(19) United States
(12) Patent Application Publication
(10) Pub. No.: US 2024/0258596 A1
(43) Pub. Date: Aug. 1, 2024

(54) GRAPHITE RECYCLING FROM LI-ION BATTERIES

(71) Applicant: Worcester Polytechnic Institute, Worcester, MA (US)

(72) Inventors: Yan Wang, Shrewsbury, MA (US); Zeyi Yao, Worcester, MA (US); Xiaotu MA, Worcester, MA (US)

(21) Appl. No.: 18/427,320

(22) Filed: Jan. 30, 2024

Related U.S. Application Data
(60) Provisional application No. 63/441,913, filed on Jan. 30, 2023.

(51) Int. Cl. H01M 10/54; C01B 32/21; C22B 1/16; C22B 7/00; H01M 4/02; H01M 4/583

(52) U.S. Cl. CPC H01M 10/54; C01B 32/21; C22B 1/16; C22B 7/007; H01M 4/583; C01P 2002/72; C01P 2002/82; C01P 2004/03; C01P 2006/40; H01M 2004/027

(57) ABSTRACT

A purification process for recycled graphite for use as anode material in Li-ion batteries includes a sequence of leaching and heat treatment followed by washing with deionized (DI) water and an acid wash. A graphite source results from a suitable process such as acid leaching of black mass from a battery recycling stream, where the leach removes a substantial portion of metal salts used for cathode materials. Impurities, most notably aluminum oxide and residual cathode materials, are often present in trace amounts in the graphite source. A sequence of heating (sintering) and pH adjusted washing further purifies the graphite into a modified, recycled graphite exceeding 99.5% purity for use in a recycled battery.

### RELATED APPLICATIONS

This patent application claims the benefit under 35 U.S.C. § 119(e) of U.S. Provisional Patent App. No. 63/441,913, filed Jan. 30, 3023, entitled “GRAPHITE RECYCLING FROM LI-ION BATTERIES,” incorporated herein by reference in entirety.

### STATEMENT OF FEDERALLY SPONSORED RESEARCH AND DEVELOPMENT

This patent application was developed, either in whole or in part, with U.S. Government support under Contract No. W911NF1920108, awarded by the US Army Research Laboratory. The Government has certain rights in the Invention.

### BACKGROUND

Li-ion batteries (LIBs) have been widely applied in recent decades, particularly with respect to electric vehicles (EV) and plug-in electric vehicles (PHEV) which have been equipped with or directly powered by LIBs. LIBs have been widely used in portable electronics, electric vehicles and grid storage as dominant power sources. Li-ion batteries include a charge material, conductive powder and binder applied to or deposited on a current collector, typically a planar sheet of copper or aluminum. The charge material includes anode material, typically graphite or carbon, and cathode material, which includes a predetermined ratio of metal salts such as lithium, nickel, manganese, cobalt, aluminum, iron and phosphorous, defining a so-called “battery chemistry” of the Li-ion cells. The preferred battery chemistry varies between vendors and applications, and recycling efforts of Li-ion batteries typically adhere to a prescribed molar ratio of the battery chemistry in recycled charge material products. A purity of the constituent products is highly relevant to the quality and performance of the recycled cells, often relying on so-called “battery grade” materials, implying purity of at least 99.5%.

### SUMMARY

A purification process for recycled graphite for use as anode material in Li-ion batteries includes a sequence of leaching and heat treatment followed by washing with deionized (DI) water and an acid wash. A graphite source results from a suitable process such as acid leaching of black mass from a battery recycling stream, where the leach removes a substantial portion of metal salts used for cathode materials. Impurities, most notably aluminum oxide and residual cathode materials, are often present in trace amounts in the graphite source. A sequence of heating (sintering) and pH adjusted washing further purifies the graphite into a modified, recycled graphite exceeding 99.5% purity for use in a recycled battery.

Configurations herein are based, in part, on the observation that the increase in popularity of electric and hybrid vehicles (EV/HV) generates a large volume of spent Li-ion batteries including charge material such as NMC (Ni, Mn, Co) cathode material, and anode material including graphite and similar carbon forms. Recycling processes for NMC charge material performs leaching of the spent NMC charge material, often with augmentation using control (virgin) stock of the Ni, Mn, Co salts to achieve a predetermined ratio of the charge material metals according to technical or customer specifications. Graphite from the spent Li-ion batteries can also be recovered. Unfortunately, conventional approaches to recycling anode materials from an NMC-sourced recycling stream suffer from the shortcoming that particles of recovered graphite have impurities, most notably aluminum oxide, remaining as residue after the shredding and leaching process. It can be problematic to satisfy customer specifications for performance and physical anode material characteristics when substantial quantities of impurities remain in the recycled graphite product. Accordingly, configurations herein substantially overcome the shortcomings of conventional battery recycling by producing anode material including graphite with improved purity, at or above 99.5% purity, and approaching 99.9%.

In further detail, the disclosed approach for recycling graphite from a Li-ion battery receives an initial recycled graphite from recycling stream of dismantled Li-ion batteries including anode material, and washing the anode material in an acidic wash solution for removing residual charge material metals. Heat treatment sinters the anode material with NaOH for forming a sintered graphite from the anode material, which is then combined with a tetrahydrofuran (THF) solution to form a reduced graphite. The reduced graphite combines with a final wash solution to attain a pH between 6 and 8 (around 7) for forming a modified recycled graphite configured for use as anode material in a recycled battery.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a recycling environment suitable for use with configurations herein;

FIG. 2 shows a graphite recycling component of the Li-ion recycling environment of FIG. 1;

FIG. 3 shows iterative graphite treatment in the recycling component of FIG. 2;

FIG. 4 shows a process flow of graphite recycling and surface treatment as in FIGS. 1-3

FIGS. 5A-5E show results of surface scans and analysis of the recycled graphite as in FIG. 4; and

FIGS. 6A-6D show results of surface modification of the graphite resulting from the process of FIG. 4.

### DETAILED DESCRIPTION

In configurations depicted below, example configurations of anode material recycling are shown. Li-ion batteries include cathode charge material, or cathode material, and anode charge material, or anode material. Cathode materials include metal salts of charge material metals such as Ni, Mn and Co in a predetermined ratio. Anode materials are usually formed from graphite or a related form of carbon. Traditionally, recycling efforts often focus on the charge material metals of the cathode material due to the relatively high cost of these mined materials, however anode material recovery has also been recently trending due to the value of the recycled graphite.

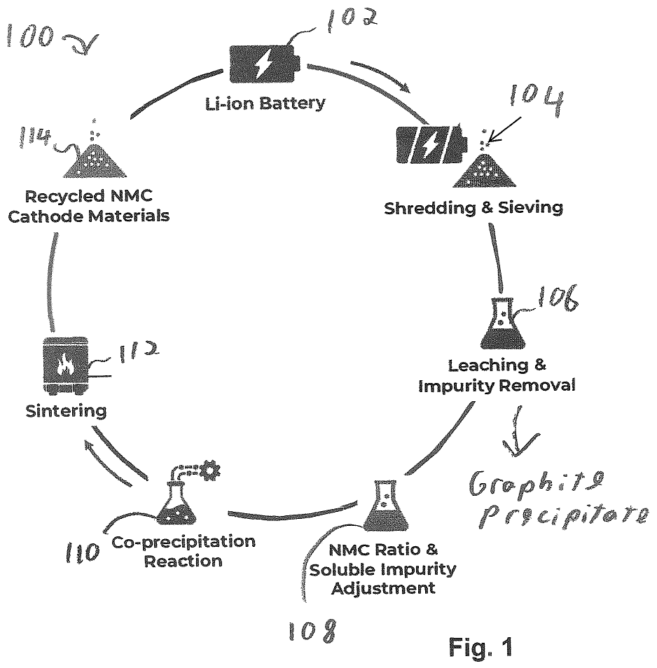

FIG. 1 is a context diagram of a recycling environment suitable for use with configurations herein. Referring to FIG. 1, a recycling scenario 100 begins with a deployed Li-ion battery 102, typically from an EV. Li-ion batteries 102 have a finite number of charge cycles before the ability of the charge material to accept sufficient charge degrades substantially. Add to this the batteries from premature end-of-life due to vehicle failure, collision damage, etc. The collective end-of-life recycling stream contributes to an abundant supply of exhausted batteries comprising spent cells and charge material 104. The batteries are discharged and agitated into a granular black mass through physical grinding, shredding and pulverizing. A leach process receives the black mass including the charge material and any incidental casing and current collectors of copper and aluminum. The black mass, including both cathode material of cathode material metal salts and anode materials of carbon and graphite, is used to form a leach solution 106 of dissolved charge material metals. The recycling stream is typically sourced from Ni, Mn and Co (NMC) Li-ion batteries, and leached with H₂SO₄, however other suitable leach agents may be employed.

The leach solution is then separated from the graphite rich precipitate for harvesting purified graphite, discussed further below, while the leach solution follows a separate recycling branch. For completeness, the leach solution includes at least Ni, Mn and Co in a sulfate solution from sulfuric acid leaching, however other charge material metals and/or leach acid may be employed. The leach solution 106 has a molar ratio of charge material metals (Ni, Mn and Co) based on the constituent composition of the incoming recycling stream. The molar ratio is adjusted with additional metal salts (Ni, Mn and Co salts), such as sulfate salts (typically a virgin or control form of fresh materials) to yield a target ratio-adjusted solution 108.

A coprecipitation reaction occurs in one or more vessels 110 by adjusting the pH of the leach solution for precipitating the charge material metals (charge materials) in the desired ratio resulting from the adjustment. Sodium hydroxide or another strong base causes the charge material metals, such as NMC, to fall out of solution in a granular form, separable by filtration, typically as hydroxides. This granular form coprecipitated from the pH adjustment of the leach solution is a cathode material precursor, having the desired molar ratio for a target battery chemistry for new, recycled batteries. Sintering in a furnace 112 with lithium carbonate or other lithium salts forms the active cathode material 114 for the recycled Li-ion battery. In an example configuration, active cathode material LiNiₓMn_{y}Co_{z}O₂ is synthesized by sintering NiₓMn_{y}Co_{z}(OH)₂ and Li₂CO₃, where x, y and z represent the respective molar ratios of Ni, Mn and Co. Common chemistries include NMC 111, representing equal molar components of Ni, Mn and Co, NMC 811, NMC 622 and NMC 532, however any suitable molar ratio may be achieved by the ratio adjustment in the leach solution 106-108 and sintering. The recycled cathode material may then be merged back into the recycling stream as cathode material, while the process below provides the anode material for the recycled battery. Further details on NMC recycling of cathode materials are disclosed in U.S. Pat. No. 10,522,884, filed Nov. 22, 2016, entitled “METHOD AND APPARATUS FOR RECYCLING LITHIUM-ION BATTERIES,” assigned to the Applicant of the present application and incorporated herein in reference in entirety.

The remaining, post leach precipitate complements the cathode material recycling by providing a graphite source. Purification of the graphite from spent lithium-ion batteries has been found to be capable of providing anode quality graphite materials (>99.5%) for lithium-ion batteries. Purification of the graphite precipitate is achieved by a subsequent heating (roasting or sintering) and acidic wash process that removes the remaining trace impurities resulting from the cathode material recycling for surface recovery and modification of recycled graphite.

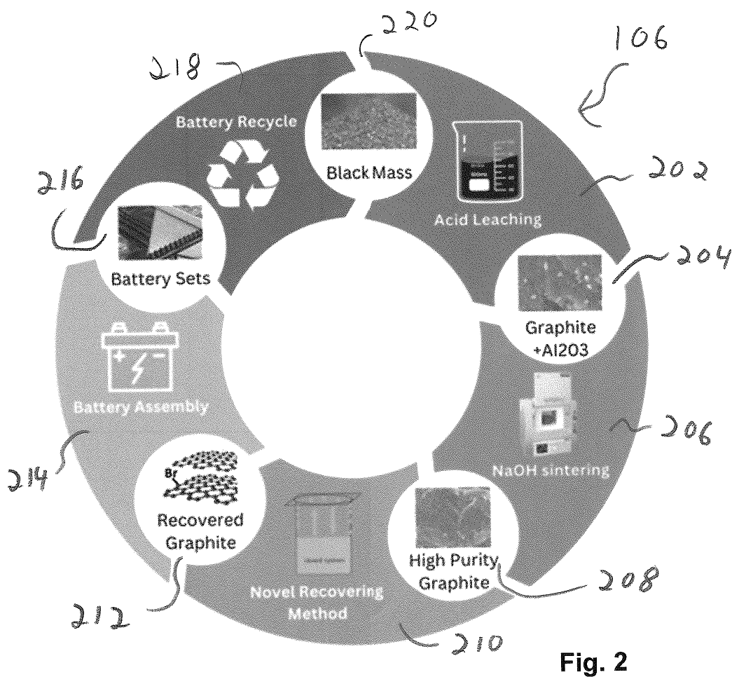

FIG. 2 shows a graphite recycling component of the Li-ion recycling environment of FIG. 1. Referring to FIGS. 1 and 2, anode recovery commences from the precipitate solids remaining from the acid leach of cathode materials at 106. Typical impurities in graphite include lithium transition metal (nickel, manganese, cobalt) oxides, transition metal sulfates and aluminum oxide. At step 202 the acid leaching method is applied to remove the lithium transition metal oxides. This typically involves additional washing/leaching with the leach agent or acid used for recovering the cathode materials, such as sulfuric acid. Due to the strong covalent bond of Al₂O₃, neither acid nor alkaline solution can completely react with it, as shown at step 204. Therefore, the disclosed approach employs a high-temperature NaOH sintering method (Al₂O₃+2NaOH=2NaAlO₂+H₂O), which successfully purifies the graphite with a purity of over 99.9%, as depicted at step 206.

However, the resulting high purity graphite (step 208) may provide sub-optimal electrochemical performance, exhibiting an initial coulombic efficiency (ICE) under 80% and poor cycle retention. Analysis of the high purity graphite (208) indicates that a possible performance inhibitor is the oxygen-related functional groups generated during the leaching and sintering steps. Based on these contaminants, the disclosed approach employs an ultra-low concentration LiAlH₄ tetrahydrofuran solvent reduction and haloid (HCl, HBr) acids leaching, as depicted at step 210. The recovered graphite then depicts an ICE of 91%, as shown at step 212, and also exhibits similar cycle stability with commercial graphite. Remarkably, the rate performance of the recovered graphite 212 is much better than the commercial ones due to a halogen anion located on the surface of graphite.

Recovered graphite, discussed in further detail below, may then merge again with the cathode material recycling for battery assembly, as depicted at step 214, deployment in EVs as battery sets, packs and/or modules (216), to finally reenter the recycling stream again at 218.

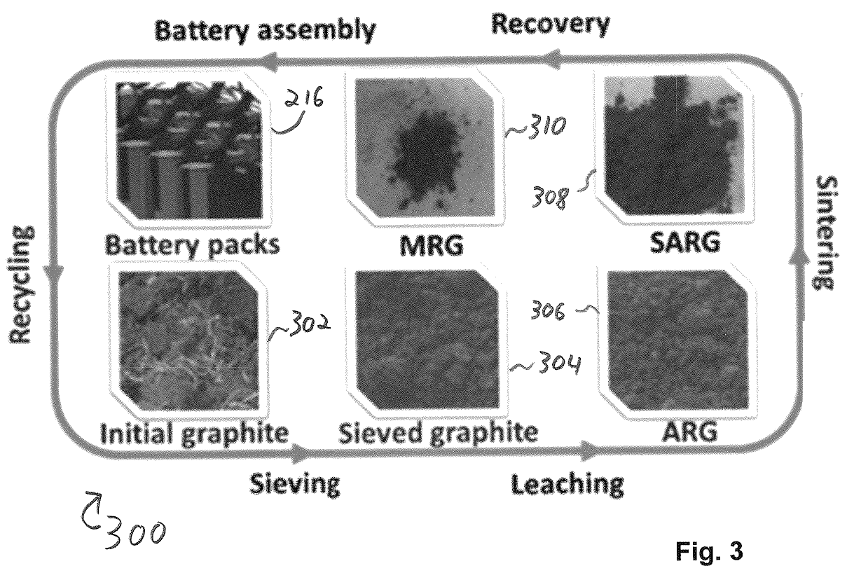

FIG. 3 shows iterative graphite treatment 300 in the recycling component of FIG. 2. Looking further into the anode material recycling, the graphite precipitate 106 from the recycling stream undergoes several stages of impurity and surface processing. From a recycling stream of battery sets, packs and/or modules from 216, the initial graphite mixture 302 results from the black mass 220 by a scalable hydrometallurgical method as in FIG. 1 and the above referenced related patent.

The mixture has parts of separators and filter paper because the spent graphite is often discarded in the recycling industry, which was first filtered out through 120 mesh to obtain the recycled graphite (RG), or sieved graphite at 304. The main impurities in RG include the remaining transition metal oxide (NMC particles), Al₂O₃, and any residual binders. Al₂O₃ tends to account for a significant proportion of the impurities since it is used as a protective layer of the separator to enhance stability and extend the service life, which can fall to the surface of electrodes during the shredding process. It brings further challenges for purification during recycling due to the solid ionic-covalent bonding within Al₂O₃.

Considering the chemical properties of the existing impurities, a two-step purification method is developed to fundamentally purify the recycled graphite. An acid leaching method is first introduced to remove the remained NMC cathode particles. Leaching of the charge material metals from a comingled recycling stream of crushed Li-ion batteries thus forms acid leached recycled graphite (ARG), as depicted at step 306. As described above, this may employ a similar acid to the leach agent used for cathode recovery.

Nano-sized Al₂O₃ particles remain distributed on the surface of ARG, indicating that Al₂O₃ cannot be completely dissolved in the leaching process. Hence, different Al₂O₃ removal strategies may be attempted, such as aqua regia and alkaline leaching. However, even at strict conditions, Al₂O₃ is still observed in the leaching process. Accordingly, the disclosed NaOH sintering method is invoked to completely remove the Al₂O₃ particles. This includes sintering the ARG with NaOH and washing with deionized water (DI) and additional NaOH to form sintered acid leached recycled graphite (SARG), thereby removing the residual aluminum oxide, as depicted at step 308. A diluted alkaline solution may be utilized first during a washing step, to remove the remaining solution in the sintered graphite (SARG) and prevent the NaAlO₂ product from hydrolyzation at the same time. Step 310 depicts synthesizing reduced recycled graphite by combining the SARG with lithium aluminum hydride (LiAlH₄) and an HCl (hydrochloric acid) solution to generate reduced recycled graphite. The resulting high purity of SARG depicts an enhancement from 97% to over 99.9% following step 310.

Configurations herein demonstrate an innovative recycling process to enable recycled cathode materials to have better performance as compared to the commercial materials. The disclosed approach is an economically feasible recycling and recovery method that enables graphite to meet commercial deployment requirements. By applying scalable acid-leaching and alkaline sintering methods, most impurities are removed, and the recycled graphite reaches a purity of over 99.9%. To overcome the poor ICE and instability issues, improved surface reconstruction and modification methods are employed. By building extra paths for Li-ion diffusion by the defects, recovered graphite (MRG) delivers an average diffusion coefficient of 4.35*10⁻⁹ cm²/s, more than 2 times higher than the commercial graphite (CG) of 1.59*10⁻⁹ cm²/s. Moreover, contributed by the recovery method, MRG possesses a recovered ICE of 91.5%, and a higher capacity of 55/50 mAh/g than the CG does under the current density of 0.5/1 C in half cells under strict commercial evaluation. Further, both MRG and CG are matched with commercial NMC622 cathode with an area capacity of over 3 mAh/cm² for full cell evaluation. Consistently, MRG full cells enable 7% and 22% higher rate retention at 0.5 C and 1 C, and doubled life cycles with over 10% average energy density compared with CG full cells. By combining the hydrometallurgical recycling process with the graphite recovery process, economic as well as environmental viability are confirmed.

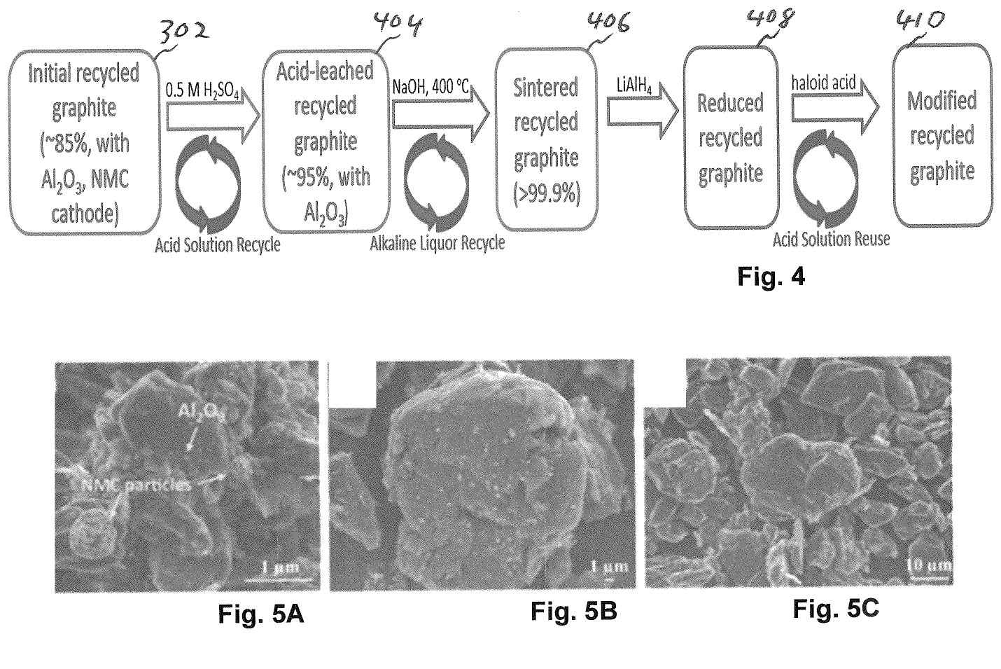

FIG. 4 shows an example use case for implementing the graphite recycling and surface treatment as in FIGS. 1-3. Referring to FIGS. 1-4, FIG. 4 shows the process for surface treatment and impurity removal of the initial recycled graphite 302. This includes washing the anode material in an acidic wash solution for removing residual charge material metal. From the initial recycled graphite, synthesis of acid-leached recycled graphite (ARG) includes mixing 0.5 M H₂SO₄ acid with the initial recycled graphite 302 for 1 hour with the solid/liquid ratio of 1:10, as depicted at step 404. The powder was first washed by a small quantity of 0.05 M H₂SO₄ for three times during filtration. Then the powder was washed by deionized (DI) water until its PH reached 7. The ARG was dried in the regular oven under 80° C. overnight.

Following the acidic leach/rinse, sintering of the anode material with NaOH forms a sintered graphite from the anode material. Synthesis of sintered recycled graphite (SARG) occurs at step 406, as 100 g of ARG was well-mixed with 100 g of NaOH; the mixture was transferred to a graphite crucible and put into a regular furnace. The temperature was increased from room temperature to 400° C. with a heating rate of 2° C. per minute and maintaining for 5 hours at 400° C. to conclude if the sintering reaction had been finished. The sintered mixture was then cooled down to room temperature and agitated or crushed into powder. The powder was mixed with 1 L of 0.1 M NaOH deionized (DI) water for 1 hour. Then the solution was filtered and the SARG was washed by 0.1 M NaOH twice and followed by DI water until the PH was around 7. Finally, the SARG was dried in the regular oven under 80° C. overnight.

The next step is synthesis of reduced recycled graphite (RRG), which includes combining a tetrahydrofuran (THF) solution with the sintered graphite to form a reduced graphite, as depicted at step 408, and includes mixing 0.5 wt % LiAlH₄ Tetrahydrofuran (THF) with the SARG with a solid/liquid ratio of 1:10 overnight. After filtration, a small amount of DI water and 1.5 M HCl solution were applied to wash to powder. The powder was transferred to a 1.5 M HCl solution with a solid/liquid ratio of 1:10 for 1 hour and washed by DI water. The resulting RRG was dried in the dry box under room temperature overnight.

Finally, synthesis of modified recycled graphite (MRG) occurs by mixing a 1 M HBr & 0.5 M H₂SO₄ solution with RRG under 75° C. for 1 hour with the solid/liquid ratio of 1:10. DI water was used during filtration until the PH was around 7. This performs washing of the reduced graphite in a final wash solution to attain a pH between 6 and 8 for forming a modified recycled graphite configured for use as anode material in a recycled battery. The MRG product yield was dried in the dry box under room temperature overnight, as depicted at step 410.

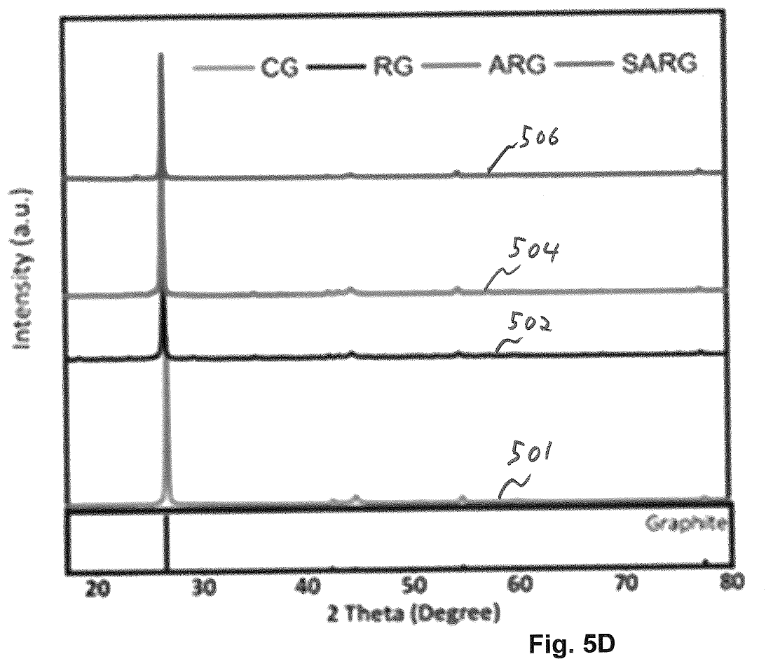

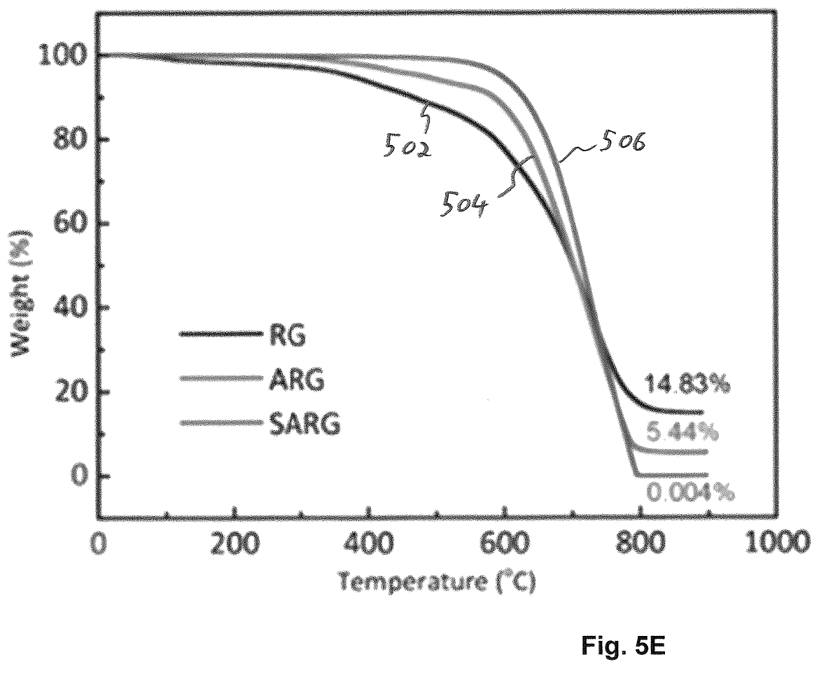

FIGS. 5A-5E show results of surface scans and analysis of the recycled graphite as in FIG. 4. Referring to FIGS. 5A-5E, FIG. 5A shows an SEM image of the initial recycled graphite (RG) 302, depicting the residual Al₂O₃. FIG. 5B shows re-leached graphite (ARG) 404, showing apparent nano-sized Al₂O₃ particles distributed on the surface of ARG, indicating that Al₂O₃ cannot be completely dissolved in the leaching process, and FIG. 5C shows the sintered graphite (SARG) 406. Note the surface qualities and the additional magnification of FIG. 5C.

FIG. 5D shows an XRD (x-Ray Diffraction) pattern of different graphite samples, including initial recycled graphite 502, ARG 504, SARG 506, and commercial graphite 501. The XRD patterns in FIG. 5D not only indicate the high purity of SARG but also exhibit the minimal effect of both purification steps on the graphite structure as little shift occurs on the peak position. Impressively, the purity of graphite is enhanced from 97% to over 99.9%, the same level as commercial graphite, and both purification steps can be scaled up to a level of hundreds of grams without any effects on the purity or yield for graphite. FIG. 5E shows a TGA (Thermogravimetric Analysis) of different graphite samples for initial recycled graphite 502, ARG 504 and SARG 506.

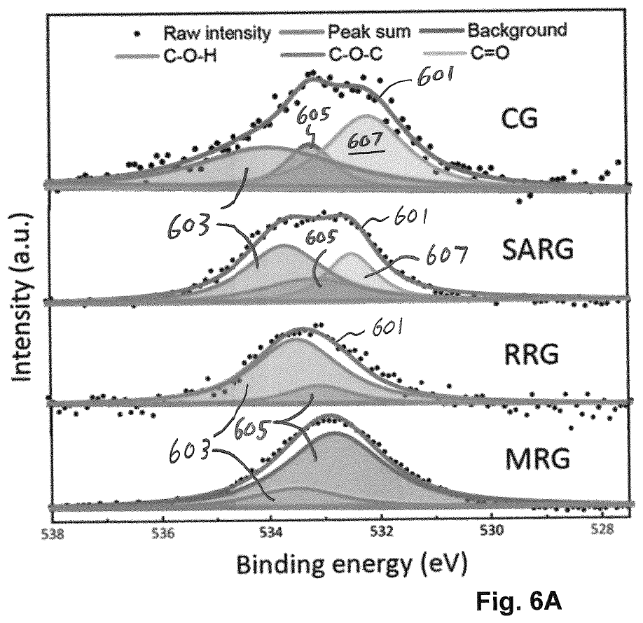

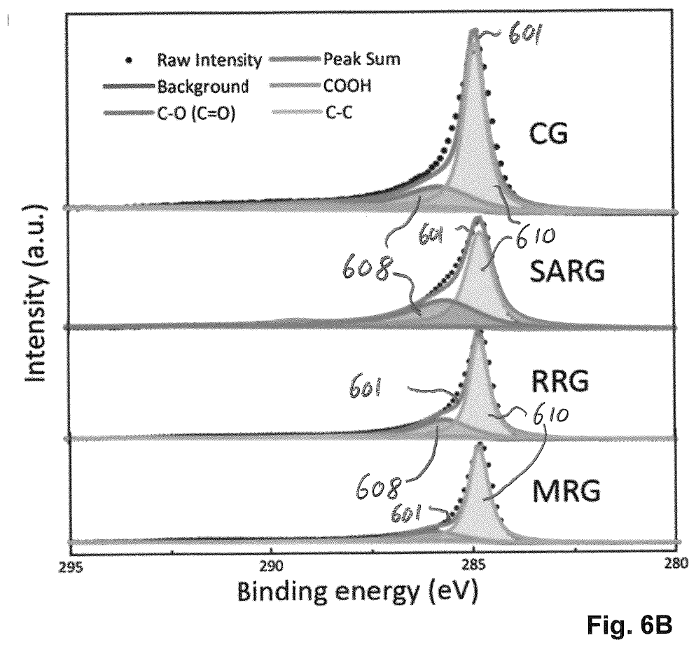

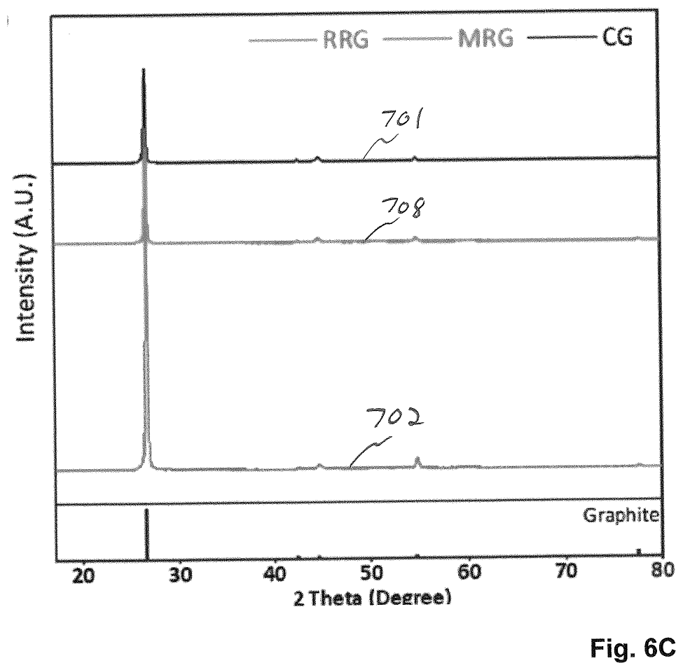

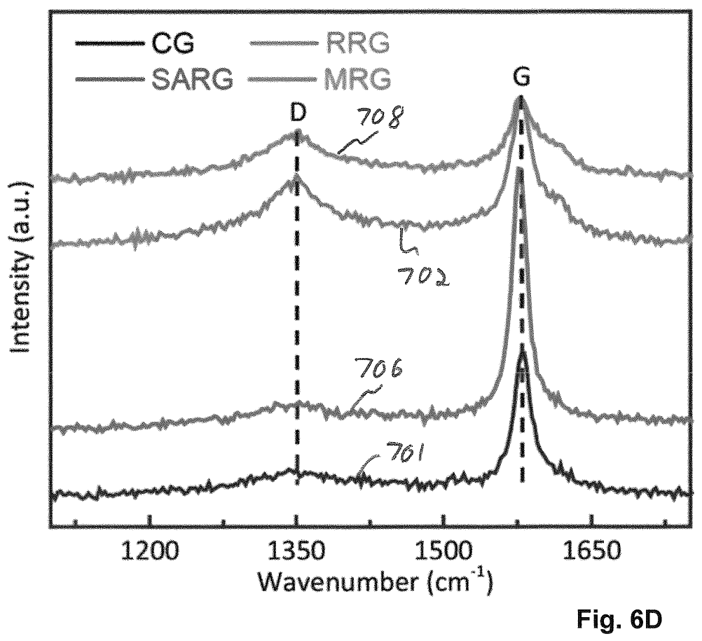

FIGS. 6A-6D show results of surface modification of the graphite resulting from the process of FIG. 4. In FIG. 6A, surface and structure characterizations for different graphite samples are shown for an XPS (X-ray photoelectron spectroscopy) spectra of O, and for C (FIG. 6B) for each of CG, SARG, RRG, and MRG. In FIGS. 6A and 6B, dotted lines for raw intensity are approximated by a peak score line 601, C—O—H shown by 603, C—O—C 605, C═O 607, C—O, C═O 608, and C—C 610. FIG. 6C shows XRD patterns of RRG 702, MRG 708, and CG701, and FIG. 6D shows Raman spectra of CG 701, SARG 706, RRG 702, and MRG 708.

Additional use cases include the following.

Al₂O₃ dissolution experiment: 50 mg of Al₂O₃ powder was mixed with 50 ml of 2 M NaOH solution under 100° C. with agitation overnight. The exact amount of Al₂O₃ powder was mixed with 50 ml of aqua regia (0.5 M HNO₃ and 1.5 M HCl) and operated under the same conditions as another attempt. Both experiments showed that Al₂O₃ cannot be completely dissolved in an acid or alkaline solution.

Preparation of acid-leached recycled graphite (ARG): 200 g of the initial graphite was sieved with a US Standard 120 mesh (125 μm). 2 L of 0.5 M H₂SO₄ was mixed with the sieved recycled graphite (RG, 197.2 g, yield 98.6%) overnight with agitation. The powder was washed with a small quantity of 0.05 M H₂SO₄ during filtration, followed by deionized (DI) water until the pH was around 7. ARG was dried in the regular oven under 80° C. Around 178.5 g of graphite was obtained.

Preparation of sintered acid-leached recycled graphite (SARG): 100 g of ARG (roughly containing 5.5 g of Al₂O₃) was well-mixed with 100 g of NaOH. The mixture was transferred into a graphite crucible and put into a regular furnace. The temperature rose from room temperature to 400° C. with a heating rate of 2° C. per minute. 1 hour was applied at 400° C. The sintered mixture was then cooled down to room temperature with a cooling rate of 2° C. per minute and smashed to powder. The powder was mixed with 1 L of 0.1 M NaOH deionized (DI) water for 1 hour. Then the solution was filtered, and the SARG was washed with a small quantity of 0.1 M NaOH and followed by DI water until the pH was around 7. Finally, SARG was dried in the regular oven under 80° C., and around 90.5 g SARG was obtained with a yield of 95.8%.

Recrystallization of the sodium salts in the washing solution: 1 L washing solution was mixed with 2 L of ethanol with agitation for 1 hour. The white powder was precipitated at the bottom of glass beaker. Filtration was followed to separate the powder and the mixed solution, washed with ethanol, and dried in a regular oven under 80° C. The solution was then heated under 120° C. The evaporated liquid was collected and NaOH powder was obtained.

Synthesis of reduced recycled graphite (RRG): Due to the limitation of the reactor volume, 200 ml of 0.5 wt % LiAlH₄ tetrahydrofuran (THF) solution was mixed with 20 g of SARG in a glass reactor in the argon (99.999%) filled glovebox. The reactor was sealed and transferred outside. The reaction was operated at room temperature overnight with agitation. After filtration, DI water, 0.1 M HCl solution, and ethanol were orderly applied to remove the extra LiAlH₄ and side products. Finally, RRG was dried in a dry box at room temperature, and around 20.0 g of RRG was obtained.

Synthesis of modified recycled graphite (MRG): 1 M HBr & 0.5 M H₂SO₄ solution was mixed with RRG (100 g) under 75° C. for 5 hours with the solid/liquid ratio of 1:10. DI water was used during filtration until the pH was around 7. The initially filtered liquid could be reused in modification after adjusting the concentration. The filtrates were recovered and reused by determining the anion concentration. MRG was dried in the dry box at room temperature overnight. Around 99.8 g of MRG was obtained.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method of recycling graphite from a Li-ion battery, comprising:
receiving an initial recycled graphite from recycling stream of dismantled Li-ion batteries including anode material;
washing the anode material in an acidic wash solution for removing residual charge material metals;
sintering the anode material with NaOH for forming a sintered graphite from the anode material;
combining a tetrahydrofuran (THF) solution with the sintered graphite to form a reduced graphite; and
washing the reduced graphite in a final wash solution to attain a pH between 6 and 8 for forming a modified recycled graphite configured for use as anode material in a recycled battery.

2. The method of claim 1 wherein the acidic wash solution further comprises a mixture of 1 M HBr and 0.5 M H₂SO₄ solution.

3. The method of claim 1 wherein the final wash solution further comprises:
washing the reduced graphite with an DI water and HCl solution; and
maintaining a solid/liquid ratio of 1:10 of the reduced graphite and the HCl solution for a predetermined duration; and
washing the reduced graphite in a mixture including at least one of HCl, HBr and H₂SO₄ to generate the modified recycled graphite.

4. The method of claim 1 further comprising leaching charge material metals from a comingled recycling stream of crushed Li-ion batteries to form acid leached recycled graphite (ARG).

5. The method of claim 4 wherein the recycling stream is sourced from Ni, Mn and Co (NMC) Li-ion batteries leached with H₂SO₄.

6. The method of claim 1 wherein the modified recycled graphite has a purity of at least 99.9% and an initial coulombic efficiency of 91.5%.

7. The method of claim 1 wherein the modified recycled graphite depicts surface defects having an peak intensity ratio of the D-band to that of the G-band (I_{d}/I_{g}) around 54.8%.

8. The method of claim 1 wherein the acidic wash solution further comprises mixing 0.5 M H₂SO₄ combined with the initial recycled graphite including the anode material for about 1 hour with a solid/liquid ratio of 1:10.

9. The method of claim 1 wherein sintering further comprises combining a substantial equal mass of NaOH with the anode material following washing, and heating at between 375°-425° C. based on increasing 2° C./minute followed by applying at least 400° C. for at least 5 hours.

10. The method of claim 1 wherein forming the reduced graphite further comprises combining 0.5 wt % THF with the sintered graphite in a 1:10 solid/liquid ratio for between 7-10 hours.

11. A method for recycling anode material from a Li-Ion battery, comprising:
leaching charge material metals from a comingled recycling stream of crushed Li-ion batteries to form acid leached recycled graphite (ARG);
sintering the ARG with NaOH and washing with deionized water (DI) and additional NaOH to form sintered acid leached recycled graphite (SARG), thereby removing residual aluminum oxide;
synthesizing reduced recycled graphite by combining the SARG with lithium aluminum hydride (LiAlH₄) and an HCl solution to generate reduced recycled graphite.

12. The method of claim 11 wherein the charge material metals include Ni, Mn and Co.

13. The method of claim 11 further comprising synthesizing the reduced recycled graphite based on a halogen anion presence on the recycled graphite.

14. A system for receiving a recycling stream of NMC batteries and recycling graphite for use as recycled anode charge material, comprising:
a receptacle for receiving an initial recycled graphite from recycling stream of dismantled Li-ion batteries including anode material;
a containment washing the anode material in an acidic wash solution for removing residual charge material metals;
a heat source for sintering the anode material with NaOH for forming a sintered graphite from the anode material;
a reactor vessel for combining a tetrahydrofuran (THF) solution with the sintered graphite to form a reduced graphite; and
a rinse process washing the reduced graphite in a final wash solution to attain a pH between 6 and 8 for forming a modified recycled graphite configured for use as anode material in a recycled battery.
